(19) United States
(12) Patent Application Publication
(10) Pub. No.: US 2007/0220028 A1
(43) Pub. Date: Sep. 20, 2007

(54) Method and system for managing load balancing in data-processing system

(76) Inventors: Masami Hikawa, Yokohama (JP); Norihiro Hara, Kawasaki (JP); Tooru Kawashima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/471,479

(22) Filed: Jun. 21, 2006

(30) Foreign Application Priority Data
Mar. 15, 2006 (JP) 2006-070402

(51) Int. Cl. G06F 7/00

(52) U.S. Cl. 707/101

(57) ABSTRACT

In a database management system, responsive to imbalances appearing in amounts of data in databases to be used by database servers, loss in performance of database management system is reduced, and the imbalances in the performances of processing of the database servers, which execute access transactions, are redressed. Allocation of CPU resources for execution of the access transactions are determined by changing or maintaining the CPU resource allocations to the database servers. Amounts of data to be used respectively by the database servers during access transactions are obtained from each database and stored into a storage device. A ratio of CPU resource allocations is calculated based upon a ratio of the amounts of data stored for the respective database servers. The CPU resource allocations for the respective database servers are changed based upon the calculated ratio.

### CROSS-REFERENCE TO RELATED APPLICATION(S)

This application claims the foreign priority benefit under Title 35, United States Code, §119 (a)-(d), of Japanese Patent Application No. 2006-070402 filed on Mar. 15, 2006 in the Japan Patent Office, the disclosure of which is herein incorporated by reference in its entirety.

### BACKGROUND OF THE INVENTION

Methods and systems consistent with the present invention relate to load balancing in a data-processing system. More particularly, the present invention relates to methods, programs and apparatuses for allocating CPU resources, as well as to database management systems in which CPU resources are allocated in a load-balanced manner.

To improve performance of a data-processing system for information retrieval, such as a database management system or DBMS, techniques related to an architecture in which processing loads on a database are distributed over and performed by multiple processors have been proposed, one example of which is disclosed in David DeWitt and Jim Gray, “Parallel Database Systems: The Future of High Performance Database Systems”, COMMUNICATIONS OF THE ACM, Vol. 35, No. 6, June 1992, pp. 85-98.

Shared-everything or shared-disk architecture as disclosed therein enables access to all disks from all hosts or processors which perform information retrieval. On the other hand, shared-nothing architecture enables each host to access only a set of disks independent of each other and dedicated to the host. The shared-nothing architecture is superior to the shared-everything architecture in less access resource conflict and greater scalability.

The shared-nothing DBMS having multiple servers includes back end servers or BESes for accessing data stored in the multiple servers. The performance of each BES depends upon the amount of data to be used thereby in the database to be accessed. When the load on processing of the BES increases, relocation of data is carried out to make the amount of data allocated in a well-balanced manner so that imbalances in performance of processing of the BES are corrected.

FIG. 12 illustrates a method for correcting the imbalances in performance of the processing through relocation of data. When the amount of data to be used becomes imbalance as a result of increase in the amount of data as shown in FIG. 12(1), access concentration on the data (database) occurs, which lowers the performance of the processing of the DB server as shown in FIG. 12(2). Therefore, the BES is moved to another DB server having available space as shown in FIG. 12(3), and thus the data in a database storage area for which the BES is responsible is divided as shown in FIG. 12(4).

However, the process of relocation of data involves redesigning the database. Moreover, the process of relocation of data involves processing (e.g., retrieving, dividing and storing) of data, which would cause detrimental effects such as temporary suspension of on-line transactions. Further, since the amount of data changes day by day, the relocation of data carried out every time when the amount of data changes would be burdensome. Thus, the operation should be reappraised periodically; i.e., an operation plan should be established. It would therefore be desirable to reduce the total cost of ownership (TCO) affected by these circumstances.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

### SUMMARY OF THE INVENTION

It is an aspect of the present invention to minimize a penalty in performance of processing of DBMS against imbalances appearing in the amount of data in the DBMS and to correct imbalances in performance of the processing.

In one embodiment of the present invention, a method for allocating CPU resources of a plurality of database servers in a database management system is provided. Each database server has a storage device for storing at least one database assigned thereto, and configured to execute access transactions with the at least one databases. The method comprises the steps of: obtaining, from each database, amounts of data to be used respectively by the database servers during access transactions, and storing the obtained amounts into a storage device; calculating a ratio of CPU resource allocations based upon a ratio of the amounts of data stored for the respective database servers; and changing the CPU resource allocations for the respective database servers based upon the calculated ratio.

The step of changing the CPU resource allocations as defined above may serve to redress imbalances in performance of the processing.

### BRIEF DESCRIPTION OF THE DRAWINGS

The above and other aspects, other advantages and further features of the present invention will become more apparent by describing in detail illustrative, non-limiting embodiments thereof with reference to the accompanying drawings, in which:

FIG. 1 is a schematic diagram illustrating one exemplary embodiment of the present invention;

FIG. 2 is a block diagram illustrating a database management system;

FIG. 3 is a diagram illustrating a hardware configuration of a computer system;

FIG. 4 is a diagram for explaining one example of statistic information;

FIG. 5 is a diagram for explaining one example of CPU resource allocations to database servers;

FIG. 6 is a flowchart showing an exemplary process of obtaining statistic information;

FIG. 7 is a flowchart showing an exemplary process of allocating CPU resources;

FIG. 8 is a flowchart showing subdivided steps of step S702 of FIG. 7;

FIG. 9 is a diagram for explaining another example of statistic information;

FIG. 10 is a diagram for explaining an example of weight balance of statistic information;

FIG. 11 is a flowchart showing an exemplary process of allocating CPU resources based upon a plurality of parameters; and

FIG. 12 is a diagram showing a method of balancing loads, which involves relocation of data, in related art.

### DETAILED DESCRIPTION OF THE EXEMPLARY EMBODIMENTS

A description will be given of a data-processing system according to an exemplary embodiment of the present invention in a database management system adopting the shared-nothing architecture. This data-processing system may be configured to allow such a shared-nothing database management system to redress imbalances in performance of the processing of back end servers without carrying out relocation of data.

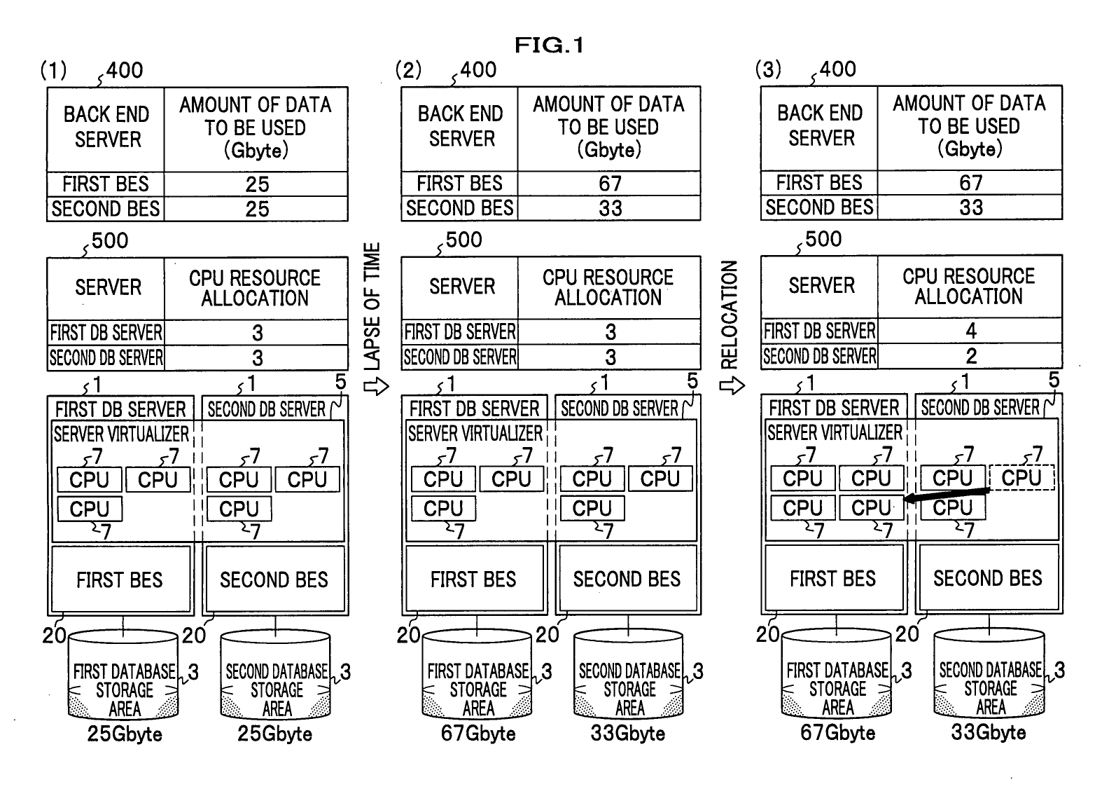

Referring now to FIG. 1, the general concept of the present invention will be described. In FIG. 1, (a), (b) and (c) transitioning in this sequence show time-varying statuses of database servers (DB servers) 1.

DB servers 1 in this embodiment each include a back end server (BES) 20. A server virtualizer 5 is provided to manage configuration of resources of the DB servers 1.

The server virtualizer 5 manages processing of central processing units (CPUs) 7, and allocates the capacities (processing powers) of the CPUs 7 to the DB servers 1 in accordance with CPU resource allocations. The CPU resource allocation may be defined by the number of CPUs, clock speed of each CPU, CPU utilization ratio based upon processing time of each CPU, and/or the other factors. To allocate the capacities of the CPUs 7, for example, the server virtualizer 5 manages correspondences between CPUs as physical devices (hardware resources) and CPUs as logical devices (software resources accessible from computer programs). The logical CPUs 7 may be embodied in a single physical CPU or in a plurality of physical CPUs.

Each back end server 20 is configured to receive a query from a user, manipulate data on a database storage area 3 of a database assigned thereto (for which the back end server 20 is responsible) in accordance with a request indicated by the query, and respond to the request (i.e., returning the result of access to the user on an as needed basis). The back end server 20 may be embodied in a single process or a plurality of processes. FIG. 1 shows that the back end server 20 in this embodiment operates in a single process.

The database management system in this embodiment is designed in conformity with the shared-nothing architecture, and the databases (including tables, indices, etc.) are divided under various techniques into a plurality of divisional tables, divisional indices, or the like which are stored separately in a plurality of database storage areas.

Since the shared-nothing architecture is adopted, each database storage area is associated with a specific back end server. The back end server is configured to access data (e.g., table data, index data) limited only to those stored in the database storage area associated with the back end server. For example, the first BES 20 handles a request for access to the first database storage area alone, whereas the second BES 20 handles a request for access to the second database storage area alone. The first and second BESes 20 never access the same storage area.

The statistic information table 400 provides information on the amounts of data to be handled by respective BESes 20. The resource allocation table 500 provides information on CPU resource allocations.

FIG. 1(a) shows a state of well-balanced capacities/performances of processing. The first and second DB servers 1 operate with three CPUs, respectively. The first and second DB servers 1 handle (relay) access to the same amount (25 Gbytes) of data, respectively.

FIG. 1(b) shows a state of imbalanced capacities/performances of processing. The amount of data in the database to be used by the first BES 20 during an access transaction has increased greatly to 67 Gbytes, whereas the amount of data in the database to be used by the second BES 20 during an access transaction has also increased, but to a relatively small extent, to 33 Gbytes. Meanwhile, the first and second DB servers 1 still operate with the same three CPUs. Consequently, the processing load placed on the first DB server 1 becomes greater than that placed on the second DB server 1, so that the imbalance becomes nonnegligible.

FIG. 1(c) shows a reestablished state of well-balanced capacities/performances of processing. The imbalance in performances of the processing has been corrected by changing the CPU resource allocations to the ratio of 4:2 (=2:1) for the first and second DB servers 1, in accordance with the ratio of the amounts of data to be used by the first and second BESes 20 (67 Gbytes:33 Gbytes nearly equal to 2:1). After an instruction to change the CPU resource allocations is issued to the server virtualizer 5, the resource allocation table 500 is updated, so that further changes in the amount of data to be used by the BESes 20 can be reflected in management of load balancing.

The method of determining whether the capacities/performances of processing are balanced or not, to be more specific, includes: obtaining from each DB server an amount of data to be used, which is formulated into the form of the statistic information table 400; and comparing the amounts of data to be used by the DB servers for each BES in the statistic information table 400. As a result of comparison, if disparities between the amounts of data fall outside a predetermined range specified by a user, CPU resource allocations adequate for each DB server are determined based upon the amounts of data to be used by the DB servers and the resource allocation table 500, and an instruction to change the CPU resource allocations for the DB servers is issued to the server virtualizer 5.

Determination as to whether the disparities between the amounts of data fall outside a predetermined range specified by a user may be made by calculating a ratio of CPU resource allocations (a:b=a/b). For example, assuming that ‘3’ is specified by a user, the predetermined range (x) turns out to be 1/3<x<3. In this instance, if the ratio ‘1:x’ or ‘x:1’ is greater than ‘3’ specified by the user, it is determined that the disparities fall outside the predetermined range specified by the user.

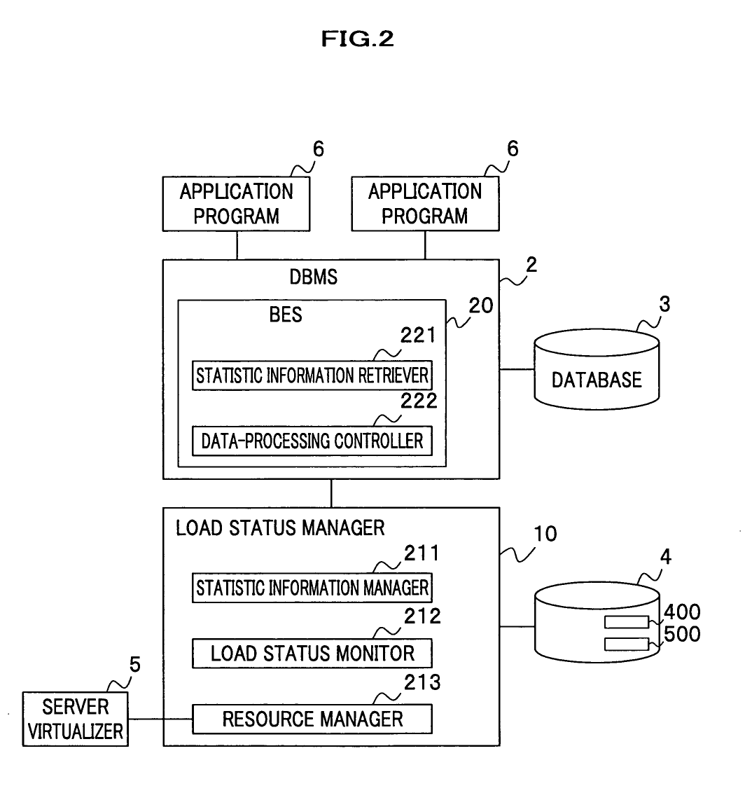

The moment of determination (as a trigger for the operation of determination) as to whether the capacities/performances of processing are balanced or not may be designed such that the amounts of data to be used are obtained from the statistic information table 400 at moments specified by a user or at any moments when the user gives an instruction to do so. Alternatively, the moment of determination may be set by making use of a timer. In this instance, the points of time for periodical monitoring (i.e., obtaining the amounts of data to be used) are predetermined, and the DBMS (a load status manager 10 thereof as shown in FIG. 2 that will be described later) issues an instruction to change or maintain the CPU resource allocations, at the moments when a timer event is generated. The use of a timer as discussed above may advantageously alleviate a burden of the user (administrator).

FIG. 2 schematically shows a database management system 2 according to an exemplary embodiment of the present invention.

The database management system 2 is communicatively connected with other systems via networks or the like. A load status manager 10 and a back end server (BES) 20, as shown in FIG. 2, do not necessarily have to be installed on one and the same data-processing system. Instead, the load status manager 10 and the BES 20 may be installed on separate data-processing systems, respectively, which are communicatively coupled with each other via a network or other means for communication, so that they can cooperate with each other and function appropriately for a consistent database management system 2.

The database management system 2 manages a database system as a whole, which management includes: handling of queries received; and managing of its available resources. The database management system 2 includes a back end server 20, and is configured to communicate with a user-generated application programs (programs) 6 and load status manager 10. The load status manager 10 is configured to communicate with a server virtualizer 5 that manages CPU resource allocations.

The database management system 2 is communicatively coupled with a database 3 for persistently or temporarily storing data to be accessed. The load status manager 10 is communicatively coupled with the statistic information table 400 and the resource management table 500. The statistic information table 400 has information on the amounts of data to be used by database servers, and the resource management table 500 has information on the CPU resource allocations to the database servers.

The back end server 20 includes a statistic information retriever 221 and a data-processing controller 222. The statistic information retriever 221 is configured to retrieve the amounts of data to be used by the database servers in response to a request from the load status manager 10, and to transmit the retrieved amounts to the load status manager 10. The data-processing controller 222 is configured to exercise control (for access or the like) over the data on the database 3 in response to a request for access received from a user.

To be more specific, the data-processing controller 222 of the back end server 20 is configured to receive and analyze a query submitted from an application program 6 and then establish access to the database 3 stored in an external storage device in accordance with a request provided in the query, and to return a result of the access to the application program 6 on an as-needed basis.

One database management system 2 may include a plurality of back end servers 20, so that efficiency and reliability secured by parallel processing can be enhanced and thus fast data processing can be performed over a large-scale database. In this instance, the amount of data to be used by a database server are obtained to calculate the CPU resource allocation, by summing up the amounts of data to be used by the back end servers 20 belonging to the same database server. The calculated CPU resource allocation to the database server may be distributed equally to the back end servers 20 belonging to the same database server, or proportionately with the ratios of the amounts of data to be used by the back end servers 20.

The load status manager 10 includes a statistic information manager 211, a load status monitor 212 and a resource manager 213. The load status manager 10 is configured to determine CPU resource allocations to be required for database servers, based upon the obtained amounts of data to be used by the database servers. The statistic information manager 211 is configured to manage the statistic information obtained by the statistic information retriever 221 of each back end server 20. The load status monitor 212 is configured to provide the amounts of data to the statistic information manager 211. The resource manager 213 is configured to determine the CPU resource allocations, and to instruct the server virtualizer 5 to allocate the CPU resources (i.e., change or maintain the allocations) in accordance with the determined allocations.

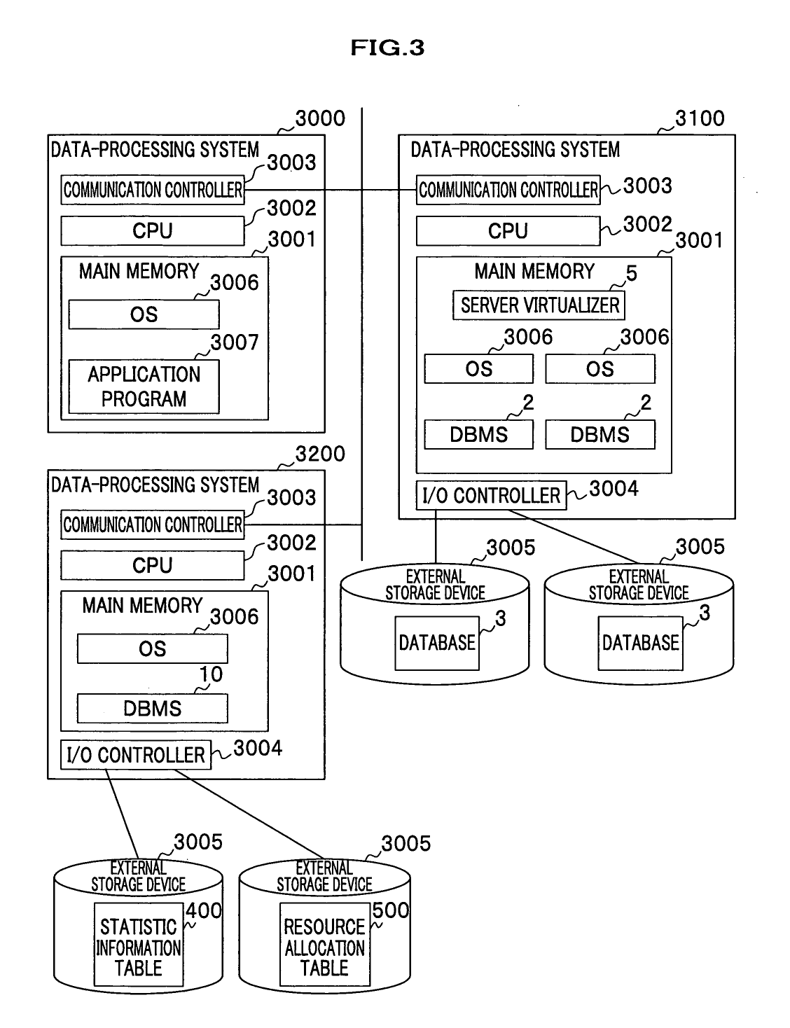

FIG. 3 shows one example of hardware configuration of the computer system according to an exemplary embodiment of the present invention. Each data-processing system (3000, 3100 and 3200) making up the computer system principally includes a memory as a storage means for use in various operations, and a processing unit for performing the operations. The memory may be implemented by known devices such as a random access memory or RAM. The operations are performed by the arithmetical unit composed of at least one CPU which loads a program into the memory for execution. In the present embodiment, the computer system further includes at least one program (application program 3007) for causing each data-processing system to execute specific operations, and at least one computer-readable storage medium for storing the at least one program.

The data-processing system 3000 includes a CPU 3002, a main memory 3001 and a communication controller 3003. An operating system or OS 3006 and the loaded application program 3007 reside in the main memory 3001 and operate by means of the CPU 3002.

When the application program 3007 issues a user query to the back end server 20 of the database management system 2, a request for responding the query is transmitted to the database management system (DBMS) 2 through a network by means of the communication controller 3003 of the data-processing system 3000 and the communication controller 3003 of the data-processing system 3100.

The data-processing system 3100 includes at least one CPU 3002, a main memory 3001, a communication controller 3003, an I/O controller 3004 and at least one external storage device 3005 such as a magnetic disk unit, etc.

In the main memory 3001 of the data-processing system 3100, a server virtualizer 5 is deployed, and a plurality of operating systems or OSes 3006 reside. A database management system 2 including a back end server 20 operating on each OS 3006 reside in the main memory 3001, and each database management system (DBMS) 2 operates by means of the CPU(s) 3002 which has been allocated thereto by the server virtualizer 5.

Databases 3 are stored in the external storage devices 3005 and managed by the database management systems 2.

The back end servers 20 perform read/write operations of data recorded in the external storage devices 3005 through the I/O controller 3004, and transmit and receive data to and from other data-processing systems connected through the network, by means of the communication controller 3003.

An operating system or OS 3006 resides in the main memory 3001 of the data-processing system 3200, and a database management system (DBMS or a load status manager 10 thereof) is deployed on the OS 3006 and operates by means of the CPU 3002. A statistic information table 400 and a resource allocation table 3005 are stored in the external storage devices 3005 and managed by the load status manager 10.

The load status manager 10 is configured to establish connection with the other data-processing systems connected through the network, by means of the communication controller 3003, to obtain the statistic information table 400, and to store the obtained statistic information table 400 into the external storage device 3005 by means of the I/O controller 3004. Similarly, the resource allocation table 500 is stored into the external storage device 3005.

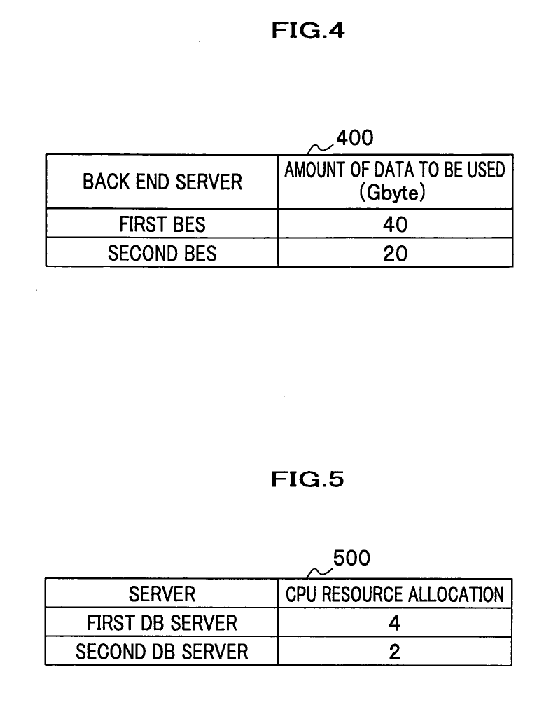

FIG. 4 shows one example of the statistic information table 400. The statistic information table 400 contains information on correspondences between the back end servers and the amounts of data to be used by the back end servers. For example, it is shown that 40 Gbyte of data are available to the first BES 20, and 20 Gbyte of data are available to the second BES 20.

FIG. 5 shows one example of the resource allocation table 500 for use in managing the CPU resource allocations to the respective DB servers. The resource allocation table 500 contains information on correspondences between the servers and the CPU resource allocations. For example, it is shown that four CPUs are allocated to the first DB server, and two CPUs are allocated to the second DB server.

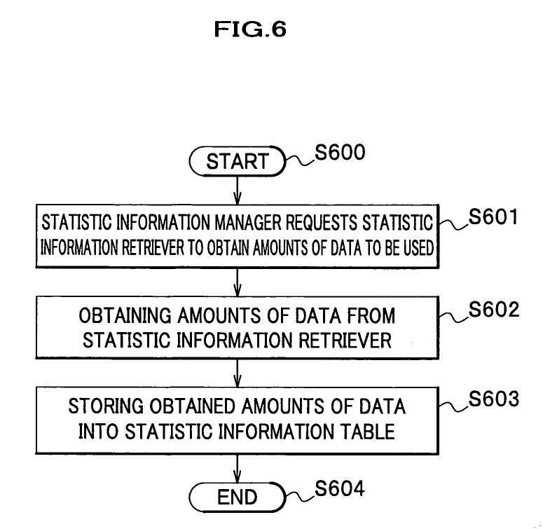

FIG. 6 is a flowchart showing a process of obtaining statistic information according to an exemplary embodiment of the present invention. The statistic information manager 211 starts the process (S600). The statistic information manager 211 requests the statistic information retriever 221 to obtain the amounts of data to be used by the back end servers 20 in response to the instruction from the load status monitor 212 (S601). The statistic information manager 211 obtains the amounts of data to be used by the back end servers 20, from the information retriever 221 (S602). The statistic information manager 211 stores the obtained amounts of data into the statistic information table 400 (S600). The statistic information manager 211 then terminates the process (S604).

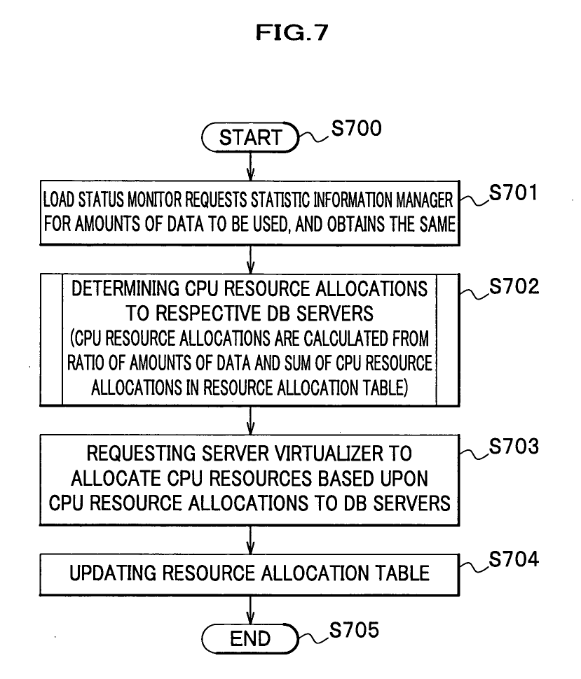

FIG. 7 is a flowchart showing a process of allocating CPU resources. This process is executed after the process shown in FIG. 6. The load status monitor 212 starts the process (S700). The load status monitor 212 requests the statistic information manager 211 for the amounts of data to be used by the back end servers 20, and obtains the same (S701). The resource manager 213 determines CPU resource allocations to respective database servers 1, based upon the obtained data to be used by the back end servers 20 (S702). The CPU resource allocations are calculated from the ratio of the amounts of data and the sum of the CPU resource allocations in the resource allocation table 500.

The resource manager 213 requests the server virtualizer 5 to allocate CPU resources based upon the calculated CPU resource allocations to the respective database servers 1 (S703). The resource manager 213 then updates the resource allocation table 500 (S704) and terminates the process (S705).

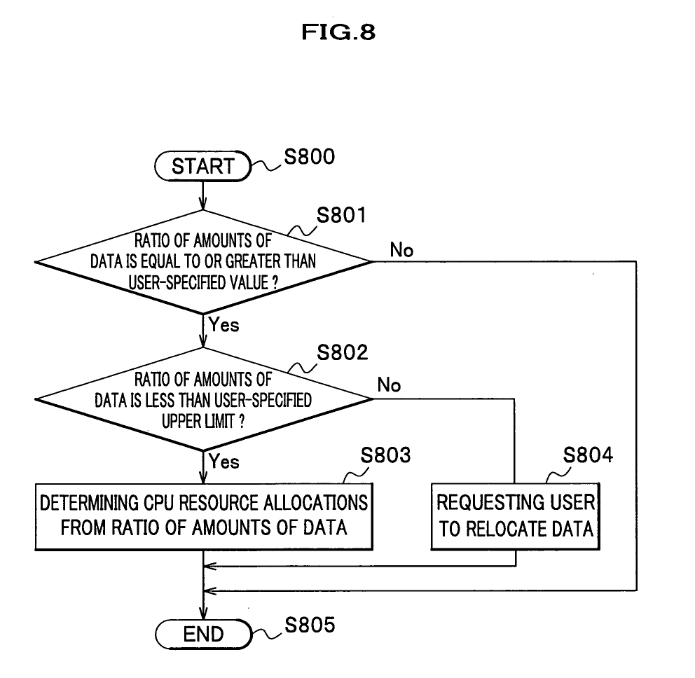

FIG. 8 is a flowchart representing a detailed process of step S702 of FIG. 7. The resource manager 213 starts the process (S800). The resource manager 213 determines whether or not the following branching condition is satisfied: the ratio of the amounts of data to be used by the back end servers 20 is equal to or greater than a user-specified value (S801). If the condition is satisfied (Yes in S801), then the resource manager 213 goes on to execute the process of S803, and if the condition is not satisfied (No in S801), then the resource manager 213 terminates the process (S805) because the CPU resource allocations need not be changed.

The resource manager 213 determines whether or not the following branching condition is satisfied: the ratio of the amounts of data to be used by the back end servers 20 is less than a user-specified upper limit (S802). If the condition is satisfied (Yes in S802), then the resource manager 213 goes on to execute the process of S803, and if the condition is not satisfied (No in S802), then the resource manager 213 goes on to execute the process of S804. This condition for determination in S802 may be modified to one which determines whether or not the amount of data to be used by each back end server 20 is less than a user-specified upper limit. This modification enables detection of rapid and simultaneous increase in the amounts of data which are to be compared.

The resource manager 213 determines preferable CPU resource allocations from the ratio of the amounts of data to be used by the respective back end servers 20 (S803). Each CPU resource allocation may be represented by the product of a ratio of allocation to each back end server 20 and a multiplier therefor. The greater the multiplier, the more CPU resources are allocated. Preferably but not necessarily, a ratio (hereinafter referred to as “standard ratio”) of a CPU resource allocation and an amount of data the CPU resource can manipulate normally may be prepared in advance by statistical techniques or the like. The standard ratio may be used to determine the multiplier, or compared with the ratio of the determined CPU resource allocation and the amount of data to be used by the relevant back end server 20, so that a CPU resource allocation is not too much deviated from an adequate capacity of the CPU resource as defined by the standard ratio.

Allocation of CPU resources considered to be too much in view of the standard ratio can thus be prevented, so that waiting time (idle state) of the CPUs can be reduced to thereby improve the utilization efficiency. On the other hand, allocation of CPU resources considered to be too short in view of the standard ratio can also be prevented, so that possibilities of slowdown of processing (due to shortage of capacity) of CPUs can be reduced to thereby increase speeds of access to the data.

The resource manager 213 requests a user to relocate data (S804). The resource manager terminates the process (S805).

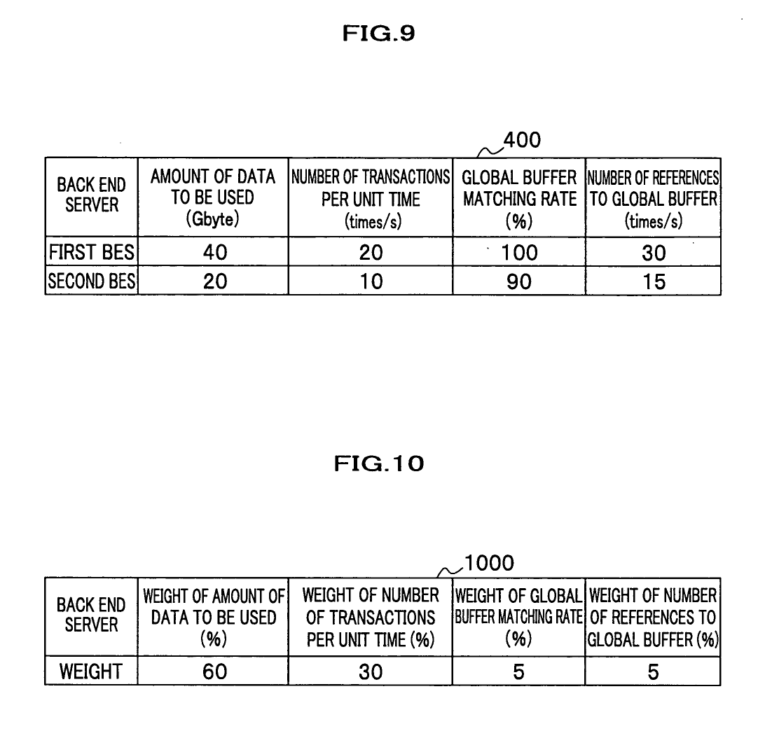

FIG. 9 shows one example of the statistic information table 400 in which not only the amounts of data to be used by the back end servers 20 but also other factors are stored as parameters associated with the respective back end servers 20. Although the imbalance in the amounts of data to be used by the back end servers 20 is taken as an example of factors which make the processing of DBMS imbalance in the description given above, other factors may be employed as parameters. CPU resource allocations may be determined by using, as parameters, at least one of factors selected (as shown in FIG. 9) from those which are enumerated below:

(the parameters given below are factors such that the larger the values, the more the CPU resource allocations should be)

(a) amounts of data to be used by back end servers 20;

(b) the number of transactions per unit time (the number of multiple runs);

(c) parameters relating to a global buffer, such as a capacity of the global buffer, a global buffer matching rate, and the number of references to the global buffer, where the global buffer refers to a cache which is created in a shared memory to temporarily stores data of the databases;

(the parameters given below are factors such that the smaller the values, the more the CPU resource allocations should be)

(d) parameters relating to exclusive processing among processes in a single BES, such as waiting time, the number of runs, etc.;

(e) parameters relating to I/O processing or access transactions with the databases, such as waiting time, the number of runs, etc.

FIG. 10 shows a plurality of exemplified weighted factors in table (weight balance table) 1000 of statistic information for use in determining the allocations of CPU resource allocations. For example, it is shown that the CPU resource allocations are determined under influence of: the amount data to be used in the proportion of 60%; the number of transactions per unit time in the proportion of 30%; the global buffer matching rate in the proportion of 5%; and the number of references to the global buffer in the proportion of 5%. These proportions of influence are used as multipliers (weights) for the geometric mean, by which the calculated CPU resource allocations are multiplied.

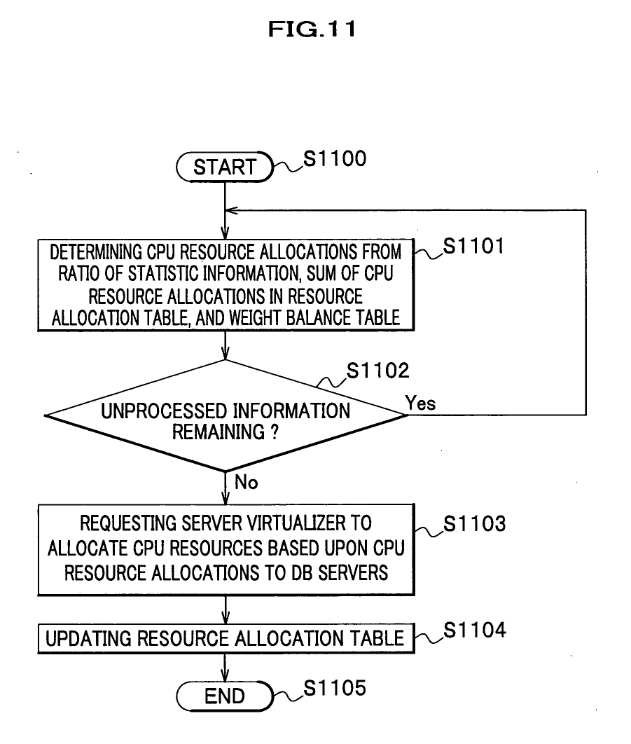

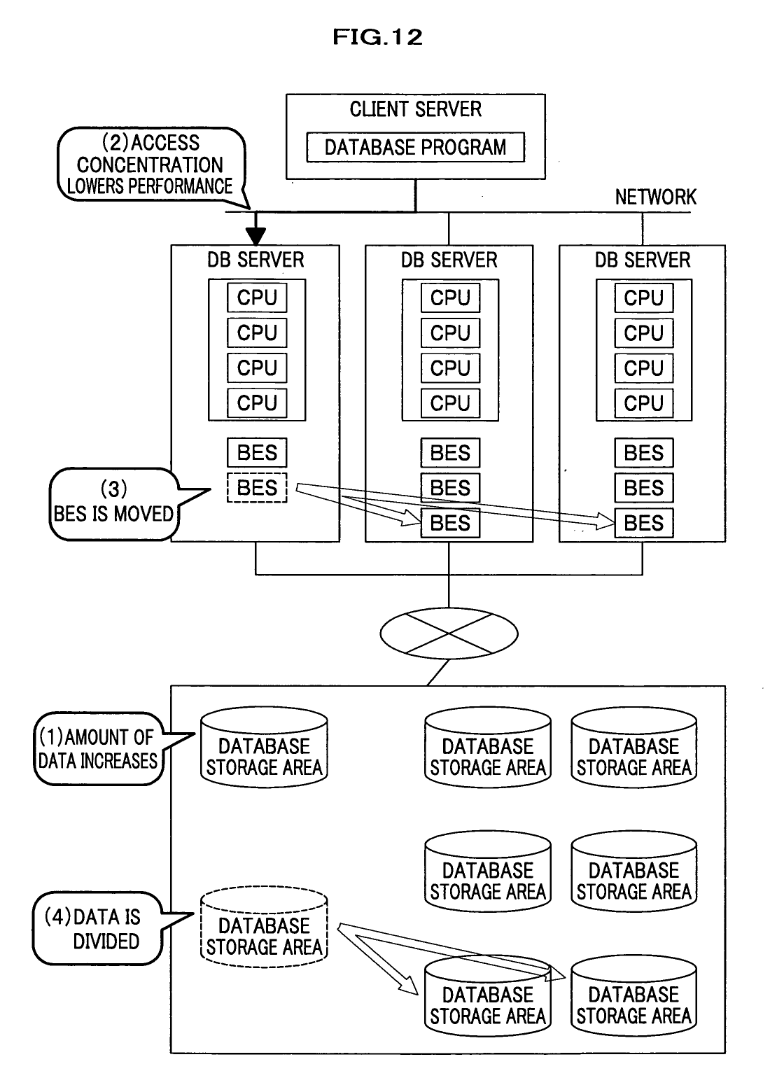

FIG. 11 shows a flowchart of a process in which more than one of the parameters in the statistic information table 400 is used. The resource manager 213 starts the process (S1100). The resource manager 213 determines CPU resource allocations from the ratio of the obtained statistic information, the sum of CPU resource allocations in the resource allocation table 500, and the weight balance table 1000 (see FIG. 10) (S1101). The resource manager 213 determines whether or not the following branching condition is satisfied: there is unprocessed information remaining (S1102). If the condition is satisfied (Yes in S1102), then the resource manager 213 proceeds to execute the process of S1101, and if the condition is not satisfied (No in S1102), then the resource manager 213 proceeds to execute the process of S1103. Hereupon, the “unprocessed information” refers to any parameters that have not yet been used to calculate the CPU resource allocations.

The resource manager 213 requests the server virtualizer 5 to allocate the CPU resources based upon the calculated CPU allocations to the respective database servers 1 (S1103). The resource manager 213 then updates the resource allocation table 500 (S1104), and terminates the process (S1105).

According to the exemplary embodiments as described above, the shared-nothing DBMS is adapted to determines whether an imbalance has become nonnegligible in the amounts of data among divisional databases, for which the respective back end servers are responsible, from the statistic information, and if such an imbalance has been detected, the CPU resource allocations to be used by the respective back end servers that are responsible for the divisional databases are changed so that the imbalance in performance of processing can be corrected.

According to the exemplary embodiments, much more advantageously in comparison with any existing prior-art techniques, a drop in performance of processing of DBMS can be reduced without carrying out burdensome data relocation, and imbalances in performance of its processing can be redressed.

It is contemplated that numerous modifications may be made to the exemplary embodiments of the invention without departing from the spirit and scope of the embodiments of the present invention as defined in the following claims.

What is claimed is:

1. A method for allocating CPU resources of a plurality of database servers in a database management system, each database server having a storage device for storing at least one database assigned thereto and configured to execute access transactions with the at least one database, the method comprising the steps of:
obtaining, from each database, amounts of data to be used respectively by the database servers during access transactions, and storing the obtained amounts into a storage device;
calculating a ratio of CPU resource allocations based upon a ratio of the amounts of data stored for the respective database servers; and
changing the CPU resource allocations for the respective database servers based upon the calculated ratio.

2. The method according to claim 1, wherein the calculating step comprises using, in addition to the stored amounts of data, at least one of parameters which include: a parameter relating to the number of transactions per unit time; a parameter relating to a global buffer; a parameter relating to exclusive processing; and a parameter relating to I/O processing.

3. The method according to claim 2, wherein the changing step comprises leaving the CPU resource allocations unchanged if the ratio of the amounts of data falls within a predetermined range.

4. The method according to claim 3, wherein the changing step comprises allocating the CPU resources based upon a ratio of the CPU resources and the amounts of data.

5. A program embodied on a computer-readable medium for causing a computer to execute the method according to claim 1.

6. An apparatus for allocating CPU resources of a plurality of database servers for allowing a database management system to execute access transactions with a plurality of databases, each database server having a storage device for storing at least one database assigned thereto, the apparatus comprising:
a statistic information manager adapted to obtain, from each database, amounts of data to be used respectively by the database servers during access transactions, and storing the obtained amounts into a storage device;
a resource manager adapted to calculate a ratio of CPU resource allocations based upon a ratio of the amounts of data stored for the respective database servers; and
a server virtualizer adapted to change the CPU resource allocations for the respective database servers based upon the calculated ratio.

7. The apparatus according to claim 6, wherein the resource manager comprises means for obtaining at least one of parameters which include: a parameter relating to the number of transactions per unit time; a parameter relating to a global buffer; a parameter relating to exclusive processing; and a parameter relating to I/O processing, and the at least one of the parameters is used, in combination with the stored amounts of data, for calculation.

8. The apparatus according to claim 7, wherein the server virtualizer comprises means for determining whether the ratio of the amounts of data falls within a predetermined range, so that the CPU resource allocations are left unchanged if the ratio of the amounts of data falls within the predetermined range.

9. The apparatus according to claim 8, wherein the server virtualizer comprises means for allocating the CPU resources based upon a ratio of the CPU resources and the amounts of data.

10. A database management system in which CPU resources of a plurality of database servers each having a storage device for storing at least one database assigned thereto are allocated to execute access transactions with the at least one database, the database management system comprising:
a statistic information manager adapted to obtain, from each database, amounts of data to be used respectively by the database servers during access transactions, and storing the obtained amounts into a storage device;
a resource manager adapted to calculate a ratio of CPU resource allocations based upon a ratio of the amounts of data stored for the respective database servers; and
a server virtualizer adapted to change the CPU resource allocations for the respective database servers based upon the calculated ratio.

11. The database management system according to claim 10, wherein the resource manager comprises means for obtaining at least one of parameters which include: a parameter relating to the number of transactions per unit time; a parameter relating to a global buffer; a parameter relating to exclusive processing; and a parameter relating to I/O processing, and the at least one of the parameters is used, in combination with the stored amounts of data, for calculation.

12. The database management system according to claim 11, wherein the server virtualizer comprises means for determining whether the ratio of the amounts of data falls within a predetermined range, so that the CPU resource allocations are left unchanged if the ratio of the amounts of data falls within the predetermined range.

13. The database management system according to claim 12, wherein the server virtualizer comprises means for allocating the CPU resources based upon a ratio of the CPU resources and the amounts of data.

14. The program according to claim 5, wherein the calculating step comprises using, in addition to the stored amounts of data, at least one of parameters which include: a parameter relating to the number of transactions per unit time; a parameter relating to a global buffer; a parameter relating to exclusive processing; and a parameter relating to I/O processing.

15. The program according to claim 14, wherein the changing step comprises leaving the CPU resource allocations unchanged if the ratio of the amounts of data falls within a predetermined range.

16. The program according to claim 15, wherein the changing step comprises allocating the CPU resources based upon a ratio of the CPU resources and the amounts of data.
